(19) United States
(12) Patent Application Publication
(10) Pub. No.: US 2006/0282189 A1
(43) Pub. Date: Dec. 14, 2006

(54) Manufacturing control apparatus, manufacturing control method, and computer product

(75) Inventors: Shinji Akisawa, Kawasaki (JP); Yutaka Iwami, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/237,766

(22) Filed: Sep. 29, 2005

(30) Foreign Application Priority Data
Jun. 8, 2005 (JP) 2005-168370

(51) Int. Cl. G06F 19/00

(52) U.S. Cl. 700/110; 700/108

(57) ABSTRACT

An information storing unit stores information relating to the manufacturing of the product in each of a plurality of manufacturing processes. An information acquiring unit acquires, when a defect is detected in a current manufacturing process, information relating to the manufacturing of the product in a preceding manufacturing process from the information storing unit. An element determining unit determines an element in the preceding manufacturing process, which is a cause of the defect detected in the current manufacturing process, based on the information acquired.

### BACKGROUND OF THE INVENTION

1. Field of the Invention

The present invention relates to a technology for controlling manufacturing of a product in a plurality of manufacturing processes.

2. Description of the Related Art

Conventionally, in manufacturing plants where products such as hard disk drives (HDDs) are produced, tests are carried out on the products manufactured to check the number of defective-products. When there are many defective products, it is considered that there are some problems on a production line of the products, and the production line is investigated.

Since the production line is investigated after having detected many defective products, it is difficult to recover the defects on the production line quickly, thereby deteriorating the productivity of the products considerably.

A technology for preventing deterioration in the productivity by predicting inferior quality of products and detecting a defect on the production line is disclosed in, for example, Japanese Patent Application Laid-Open No. H6-168249, Japanese Patent Application Laid-Open No. H7-105285, and Japanese Patent Application Laid-Open No.H9-66443.

However, in the conventional technology, it is difficult to analyze the defective state and the cause thereof in detail. Specifically, although the cause of defective products can stem from the state of the production line in the preceding process, it is difficult to detect the cause.

In other words, even if defective products are detected in the subsequent process, the cause may not always lie in the production line relating to the process, but can lie in the equipment and products in the preceding process.

Since the defective products cannot be reduced efficiently without solving the problem in the preceding process, it is important to develop a technique for determining the defective state and the cause thereof in detail.

### SUMMARY OF THE INVENTION

It is an object of the present invention to at least solve the problems in the conventional technology.

An apparatus according to one aspect of the present invention, which is for controlling manufacturing of a product in a plurality of manufacturing processes including. a first manufacturing process and a second manufacturing process, where the first manufacturing process precedes the second manufacturing process, includes an information storing unit that stores information relating to the manufacturing of the product in each of the manufacturing processes; an information acquiring unit that acquires, when a defect is detected in the second manufacturing process, information relating to the manufacturing of the product in the first manufacturing process from the information storing unit; and an element determining unit that determines an element in the first manufacturing process, which is a cause of the defect detected in the second manufacturing process, based on the information acquired.

A method according to another aspect of the present invention, which is for controlling manufacturing of a product in a plurality of manufacturing processes including a first manufacturing process and a second manufacturing process, where the first manufacturing process precedes the second manufacturing process, includes storing information relating to the manufacturing of the product in each of the manufacturing processes; acquiring, when a defect is detected in the second manufacturing process, information relating to the manufacturing of the product in the first manufacturing process from the information stored at the storing; and determining an element in the first manufacturing process, which is a cause of the defect detected in the second manufacturing process, based on the information acquired.

A computer-readable recording medium according to still another aspect of the present invention stores a computer program that causes a computer to execute the above method according to the present invention.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic for illustrating a configuration of a manufacturing control system according to an embodiment of the present invention;

FIG. 2 is a functional block diagram of a manufacturing control apparatus and a database shown in FIG. 1;

FIG. 3 is a schematic of an example of work schedule data shown in FIG. 2;

FIG. 4 is a schematic of an example of work instruction data shown in FIG. 2;

FIG. 5 is a graph of an example of defect occurrence comparison data included in same-kind equipment-defect data shown in FIG. 2;

FIG. 6 is a graph of an example of defect-occurrence time-series data included in the same-kind equipment-defect data shown in FIG. 2;

FIG. 7 is a graph of an example of time-series defect data shown in FIG. 2;

FIG. 8 is a graph of an example of preceding-process defect data shown in FIG. 2;

FIG. 9 is a schematic of an example of optimum-parts/equipments combination data shown in FIG. 2;

FIG. 10 is a flowchart of a processing procedure for a work-schedule creating process;

FIG. 11 is a flowchart of a processing procedure for a work-instruction creating process;

FIG. 12 is a flowchart of a processing procedure for determining a defect cause based on comparison of fraction defective between same kinds of equipments;

FIG. 13 is a flowchart of a processing procedure for determining a defect cause based on a time series change in the fraction defective in single equipment;

FIG. 14 is a flowchart of a processing procedure for determining an element that is a cause of a defect in a preceding process;

FIG. 15 is a flowchart of a processing procedure for selecting a combination of parts and equipment (jigs) having a high production yield; and

FIG. 16 is a schematic of a hardware configuration of a computer to implement the manufacturing control apparatus shown in FIG. 2.

### DETAILED DESCRIPTION OF THE PREFERRED EMBODIMENTS

Exemplary embodiments of the present invention will be explained below in detail with reference to the accompanying drawings.

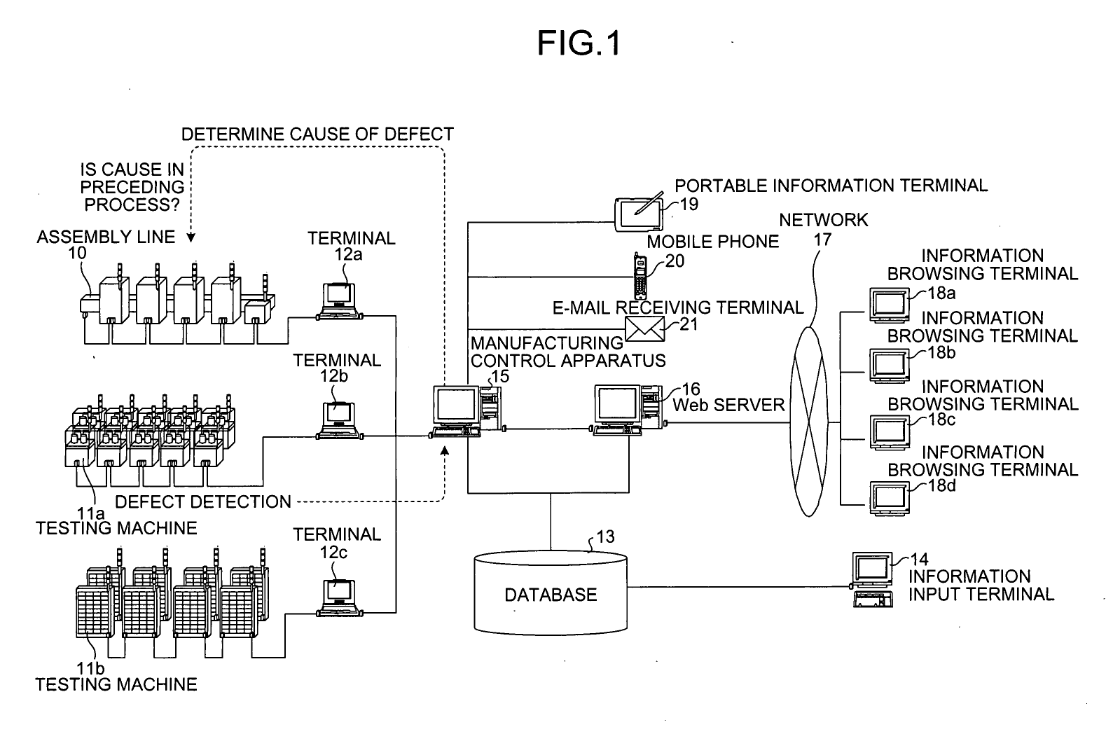

FIG. 1 is a schematic for illustrating a configuration of a manufacturing control system according to an embodiment of the present invention.

The manufacturing control system includes an assembly line 10, testing machines 11a and 11b, terminals 12a to 12c, a database 13, an information input terminal 14, a manufacturing control apparatus 15, a web server 16, a network 17, information browsing terminals 18a to 18d, a portable information terminal 19, a mobile phone 20, and an e-mail receiving terminal 21.

The assembly line 10 assembles products such as HDDs through a plurality of processes and performs processing. The assembly line 10 controls the start time and the finish time of production processing of products in each process, identification numbers of the respective equipment (jig) on the assembly line 10, lot numbers of the products, product type, identification numbers of operators, and processing result information of the production processing.

The processing result information is a defect code and the like for identifying whether a defect has occurred as a result of executing the processing in one process, when a defect has occurred, and what kind of defect has occurred.

The testing machines 11a and 11b execute tests of the products assembled by the assembly line 10. The testing machines 11a and 11b control the start time and the finish time of respective test processing, identification numbers of the respective equipment in the testing machines 11a and 11b, lot numbers of the products, the product type, identification numbers of the operators, and processing result information.

The processing result information is a defect code and the like for identifying whether a defect has been detected as a result of executing processing in a certain test, and if a defect has been detected, what kind of defect has been detected.

The terminals 12a to 12c receive various types of information controlled by the assembly line 10 or the testing machines 11a and 11b on a real-time basis, and transmit the information to the manufacturing control apparatus 15.

The database 13 is a storage device such as a HDD. The database 13 is controlled by the manufacturing control apparatus 15, and stores various types of information collected by the assembly line 10 or the testing machines 11a and 11b, and results of analysis performed by the manufacturing control apparatus 15 based on the various types of information.

The database 13 stores information of standard time required for each processing, and information such as a threshold used at the time of detecting the defect occurrence. The database 13 will be explained in detail later.

The information input terminal 14 receives an input of the information of the standard time required for each processing and the information such as the threshold used at the time of detecting the defect occurrence from an operator to store the information in the database 13.

The manufacturing control apparatus 15 performs manufacturing control of the product by collecting various types of information from the assembly line 10 or the testing machines 11a and 11b, storing the collected information in the database 13, and analyzing the information stored in the database 13.

The manufacturing control apparatus 15 not only monitors whether any defect has occurred, but also when the occurrence of a defect has been detected in a certain process, determines whether the cause of the defect is in the preceding process, and when the cause of the defect is in the preceding process, determines the cause of the defect.

The web server 16 reads the information, such as the production state of the product, the state of the processing performed in the respective production processes, aggregation results of the data collected by the manufacturing control apparatus 15, and analysis results of the data analyzed by the manufacturing control apparatus 15 from the database 13, to provide the information to the information browsing terminals 18a to 18d via the network 17 in a hypertext markup language (HTML) format.

The information browsing terminals 18a to 18d obtain the information provided by the web server 16 by accessing the web server 16, to display the information on a display and the like.

The portable information terminal 19 is a device such as a personal digital assistant (PDA) having a function of performing data communications with other devices. The mobile phone 20 performs voice communications, data communications, and the like. The e-mail receiving terminal 21 has a function of receiving e-mails.

The portable information terminal 19, the mobile phone 20, or the e-mail receiving terminal 21 obtains, via the manufacturing control apparatus 15, the information such as the production state of the product stored in the database 13, the state of the processing performed in the respective production processes, the aggregation results of the data collected by the manufacturing control apparatus 15, and the analysis results of the data analyzed by the manufacturing control apparatus 15, to display the information on the display and the like installed on the respective equipment.

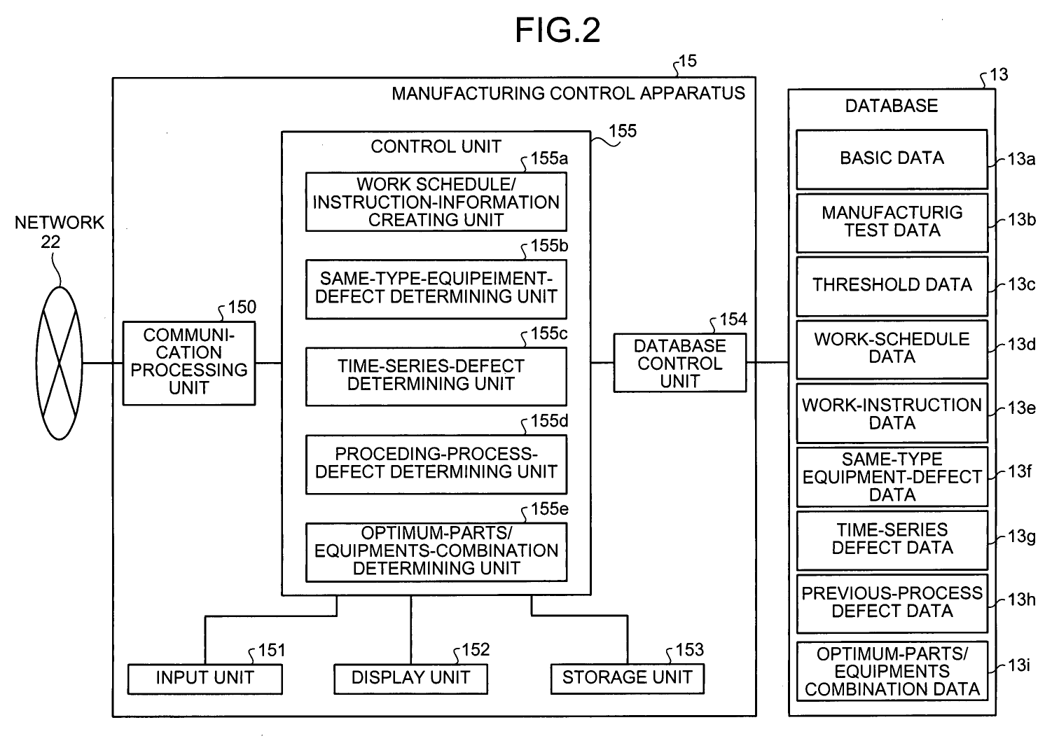

FIG. 2 is a functional block diagram of a manufacturing control apparatus 15 and a database 13 shown in FIG. 1.

The manufacturing control apparatus 15 includes a communication processing unit 150, an input unit 151, a display unit 152, a storage unit 153, a database control unit 154, and a control unit 155.

The communication processing unit 150 is a network interface that performs communications with the terminals 12a to 12c, the web server 16, the portable information terminal 19, the mobile phone 20, the e-mail receiving terminal 21, and the like.

The input unit 151 is an input device such as a keyboard and a mouse. The display unit 152 is a display device such as a display. The storage unit 153 is a storage device such as a memory and a HDD. The storage unit 153 temporarily stores data read out from the database 13, data to be stored in the database 13, the data created by arithmetic processing, and the like.

The database control unit 154 controls processing for storing data in the database 13 and reading data from the database 13. Specifically, the database control unit 154 controls processing for storing and reading various types of information controlled by the assembly line 10 or the testing machines 11a and 11b and collected by the terminals 12a to 12c on a real-time basis, the information input by the information input terminal 14, and the information relating to the analysis results of the various types of information, and the like.

The data stored in the database 13 includes basic data 13a, production/test data 13b, threshold data 13c, work schedule data 13d, work instruction data 13e, same-kind equipment-defect data 13f, time-series defect data 13g, preceding-process defect data 13h, and optimum-parts/equipments combination data 13i.

Information such as identification numbers of the respective equipment on the assembly line 10 or the testing machines 11a and 11b, installation positions of the respective equipment, the standard processing time required for the processing in the respective equipment for each kind of products, and identification numbers of operators who execute the processing in the respective equipment is stored in the basic data 13a.

Information relating to the production or the test of the products collected from the assembly line 10 or the testing machines 11a and 11b on a real-time basis is stored in the production/test data 13b.

Specifically, the start and the finish time of the respective processing in the respective processes of the assembly line 10, the identification numbers of the respective equipment on the assembly line 10, the start and the finish time of the respective test processing by the testing machines 11a and 11b, the identification numbers of the respective equipment in the testing machines 11a and 11b, the product lot number, the product type, the identification number of the operator who has executed the processing, the processing results (occurrence of a defect and content of the defect), the yield, and the like are stored in the production/test data 13b.

A threshold used for comparison and the like with the incidence rate of defects at the time of determining the cause of the defect is stored in the threshold data 13c. The threshold will be explained in detail later.

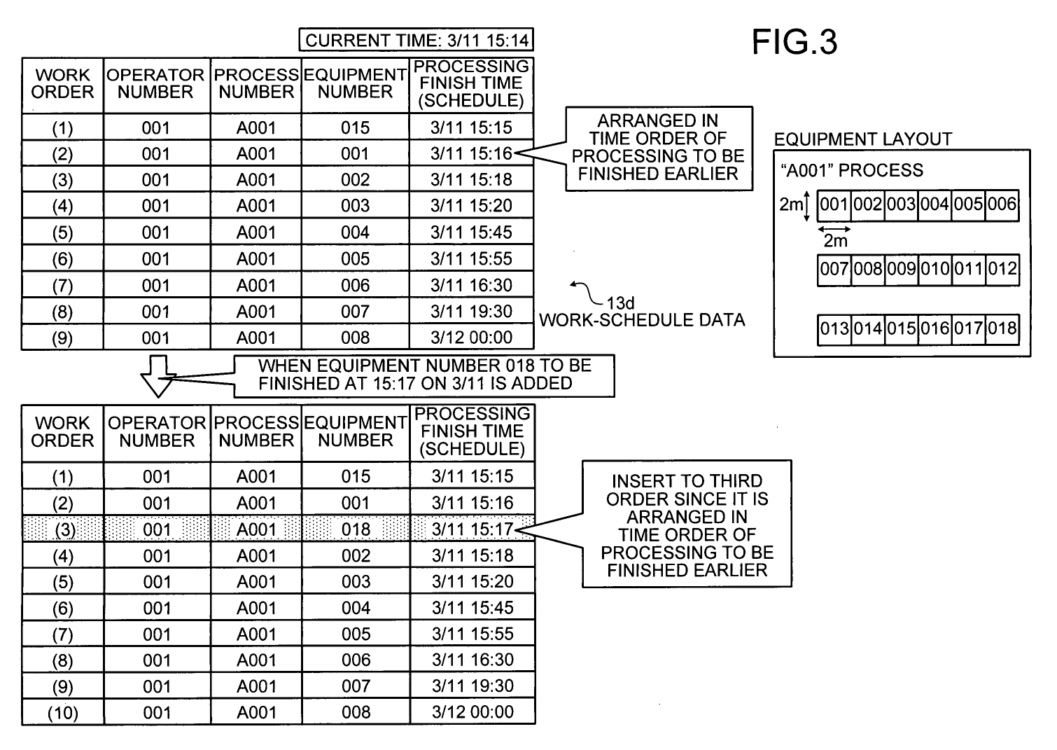

The work schedule of the processing executed by the operator by using the respective equipment on the assembly line 10 or the testing machines 11a and 11b is stored in the work schedule data 13d. The work schedule data 13d is used for understanding the work to be executed next, when there is no work instruction. FIG. 3 is a schematic of an example of work schedule data 13d shown in FIG. 2.

The respective items of the work order, the operator number, the process number, the equipment number, and the processing finish time (schedule) are stored in the work schedule data 13d. The work order is the sequence for the work. The operator number is the number assigned to the operator who executes the work. The process number is the number assigned to the work process. The processing finish time (schedule) is the scheduled finish time of the processing executed by the operator in the respective equipment.

An example in which an operator having an operator number “001” executes a process having a process number “A001” by using equipment having the equipment numbers of from “001” to “018” shown in the equipment layout is shown in FIG. 3.

In the work schedule data 13d, the operator number, the process number, and the equipment number are arranged in order of processing to be finished earlier. When new work data is added, the operator number, the process number, and the equipment number are rearranged in order of processing to be finished earlier.

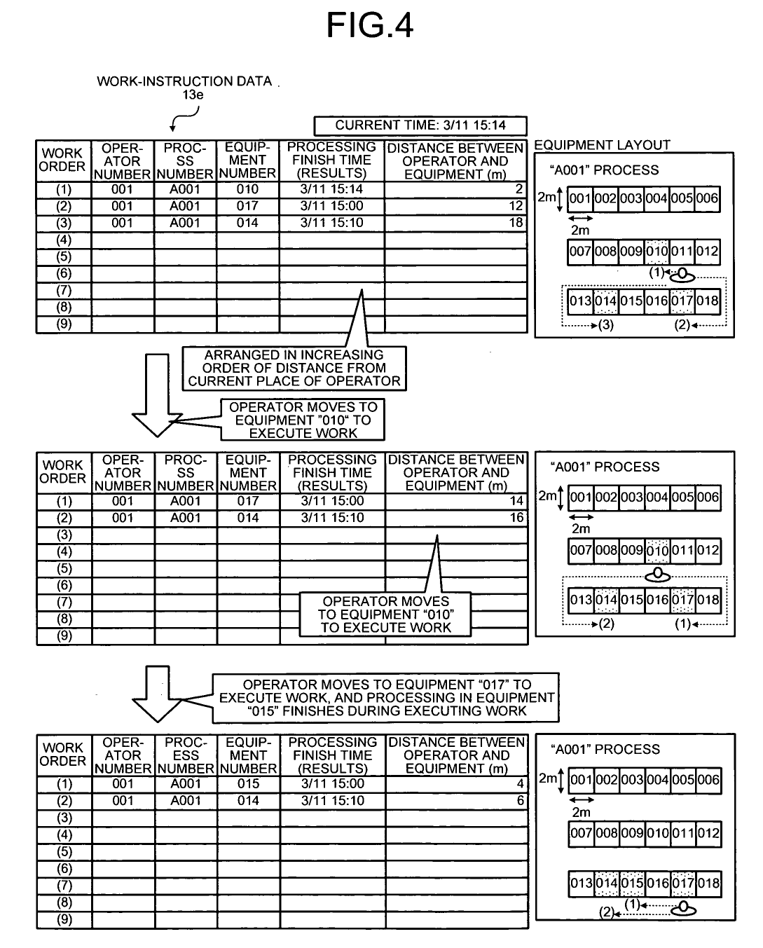

Referring back to FIG. 2, the order of work, of which execution is instructed to the operator, is stored in the work instruction data 13e. FIG. 4 is a schematic of an example of work instruction data 13e shown in FIG. 2.

The respective items of the work order, the operator number, the process number, the equipment number, the processing finish time (results), and the distance between the operator and the equipment (meter) are stored in the work instruction data 13e. The work order, the operator number, the process number, and the equipment number are the same as those in the work schedule data 13d.

The processing finish time (results) is information of the time when the processing in the respective equipment has finished. When the processing has finished, since the next processing can be executed in the equipment, the work instruction for the next processing is issued to the operator.

The distance between the operator and the equipment (meter) is a distance between the equipment in which the processing has finished and the current position of the operator. The current position of the operator is set at the position where the operator has finished the last work. The work instruction is arranged in an increasing order of the distance.

An example in which the operator having the operator number “001” executes the process having the process number “A001” by using the equipment having the equipment numbers of from “001” to “018” shown in the equipment layout is shown in FIG. 4.

When the operator moves to certain equipment (for example, equipment “010”) and executes the work according to the work instruction, the position of the equipment becomes the position of the operator, and the distance between the operator and the equipment (meter) is recalculated based on the new position of the operator.

When the operator finishes the processing in the equipment (for example, equipment “015”) having a shorter distance from the operator than the equipment (for example, equipment “014”), for which the work instruction has been issued, during working in certain equipment (for example, equipment “017”), the work order is changed so as to execute the work in the equipment (equipment “015”).

Referring back to FIG. 2, the information relating to the incidence rate of defects in the same-type equipment on the assembly line 10 or the testing machines 11a and 11b is stored in the same-kind equipment-defect data 13f.

Specifically, the defect occurrence comparison data in which information of the number of the defect occurrence, the fraction defective (%), the threshold (%), and a mean value × n in the respective same-type pieces of equipment are stored, and the defect-occurrence time-series data in which information of a time series change in the fraction defective (%) in the respective same-type pieces of equipment, a time series change in the fraction defective mean value (%) in the respective equipment, and the threshold (%) are stored, are stored in the same-kind equipment-defect data 13f.

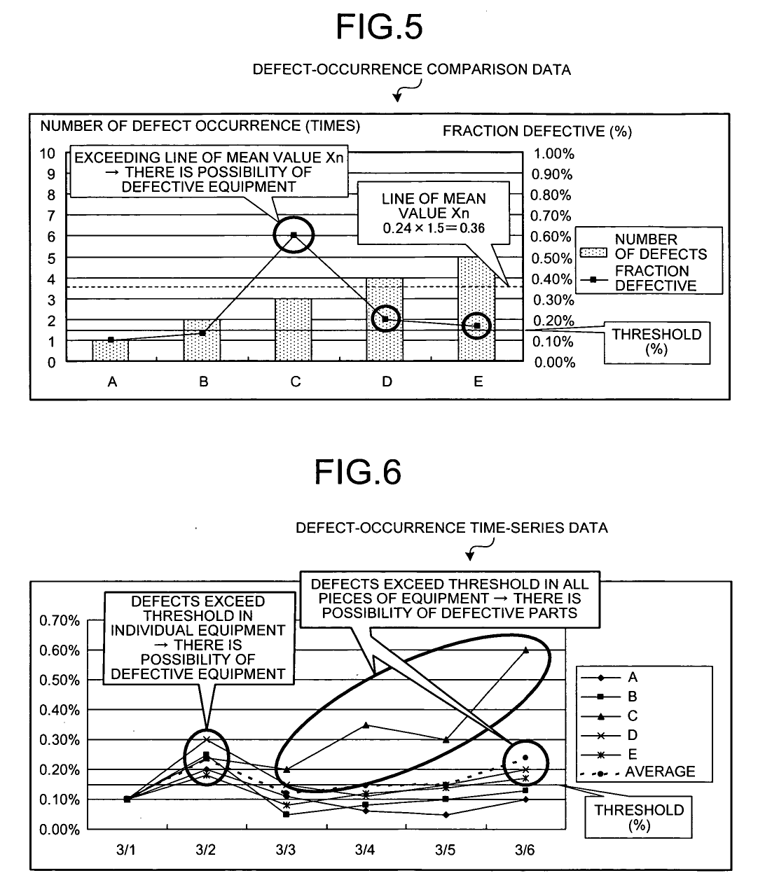

FIG. 5 is a graph of an example of defect occurrence comparison data included in same-kind equipment-defect data 13f shown in FIG. 2. The respective values are graphically shown, but the respective values are stored as numerical data in the database 13.

The defect occurrence comparison data includes the information of the number of defect occurrence, the fraction defective (%), the threshold (%), and the mean value × n in the respective same-type pieces of equipment “A” to “E”. The number of defect occurrence in the respective same-type pieces of equipment “A” to “E” is the number of defect occurrence in a certain period (one day or the like).

The fraction defective (%) is a rate of defect occurrence calculated by
Fraction defective (%)=number of defect occurrence/number of processing×100 (1)

The values of the number of defect occurrence and the number of processing are totaled from the data stored in the production/test data 13b.

The threshold is a value compared with the value of the fraction defective, and read from the threshold data 13c. If the fraction defective is larger than the threshold in all pieces of equipment “A” to “E”, it is determined that there is a high possibility that there are defective parts. When the fraction defective is larger than the threshold in a certain piece of equipment (for example, equipment “C”, “D”, or “E”), it is determined that there is a high possibility of a defect in the equipment.

The value of mean value×n is a value compared with the fraction defective. The mean value herein is a mean value (%) of the fraction defective in the respective equipment. “n” is a threshold for the mean value, and a value read from the threshold data 13c (1.5 in the example shown in FIG. 5). When the fraction defective of equipment is larger than the value of the mean value×n (for example, in the equipment “C”), it is determined that there is a high possibility of a defect in the equipment “C”.

FIG. 6 is a graph of an example of defect-occurrence time-series data included in the same-kind equipment-defect data 13f shown in FIG. 2. The defect-occurrence time-series data includes the information of a time series change in the fraction defective (%) (per day) and a time series change in the fraction defective mean value (%) in the respective pieces of equipment “A” to “E”, and the threshold (%). Respective values are graphically shown, but the respective values are stored as numerical data in the database 13.

The threshold (%) is the same as that of the defect occurrence comparison data. When the fraction defective in all the pieces of equipment “A” to “E” is larger than the threshold at a certain point in time (for example, at a point in time of 3/2), it is determined that there is a high possibility that there is a defective part.

When the fraction defective in certain equipment is larger than the threshold at a certain point in time (for example, the equipment “C” at 3/3 to 3/6, the pieces of equipment “D” and “E” at 3/6), it is determined that there is a high possibility of a defect in the equipment. Particularly, since the fraction defective exceeds the threshold every day in the equipment “C”, it is determined that the cause is not well resolved.

Referring back to FIG. 2, information relating to the time series change in the incidence rate of defects in the respective equipment on the assembly line 10 or the testing machines 11a and 11b is stored in the time-series defect data 13g. Specifically, information relating to the time series change in the fraction defective (%), the time series change of 5-day average (%) in the fraction defective, and the time series change of 25-day average (%) in the fraction defective in certain equipment, and the threshold (%) is stored in the time-series defect data 13g.

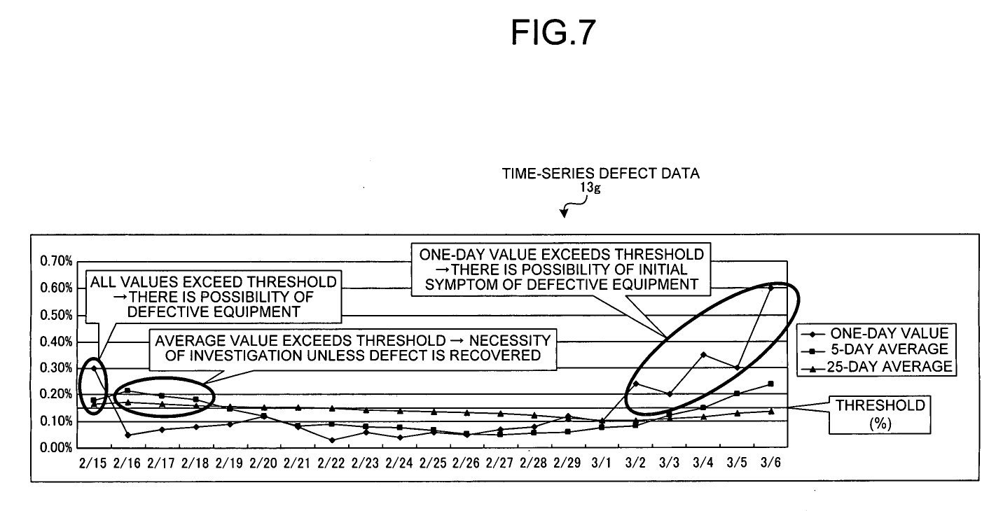

FIG. 7 is a graph of an example of time-series defect data 13g shown in FIG. 2. Respective values of the time series change in the fraction defective (%), the time series change of 5-day average (%) of the fraction defective, and the time series change of 25-day average (%) of the fraction defective in certain equipment, and the threshold (%) are graphically shown, but respective values are stored as numerical data in the database 13.

The values of 5-day average and 25-day average of the fraction defective are obtained by taking the 5-day and 25-day moving average of the fraction defective in each day calculated from Eq. (1). The threshold is a value used for the comparison with the fraction defective, the 5-day average of the fraction defective, and the 25-day average of the fraction defective.

The 5-day average is a value reflecting a short-term change in the fraction defective, whereas the 25-day average is a value reflecting a long-term change in the fraction defective. That is, the 5-day average is suitable for detecting a sudden defect occurrence, and the 25-day average is suitable for detecting a defect occurring due to a long-term use of the equipment, such as wear of the equipment.

When a fraction defective on a certain day, the 5-day average, or the 25-day average is larger than the threshold, it is determined that the equipment has a defect. When the 5-day average is larger than the 25-day average, it is determined that the equipment has a defect. This indicates that there is a possibility that some defect has suddenly occurred in the equipment.

Referring back to FIG. 2, the preceding-process defect data 13h is data relating to the defect occurrence in the preceding process if a defect is detected in a certain process, created by totaling the production data or the test data relating to the preceding process.

Specifically, the defect content in a certain process, the totaling result of the frequency of defects for each processing equipment in the preceding process, the totaling result of the frequency of defects for each processing result in the preceding process, and the like are stored in association with each other in the preceding-process defect data 13h.

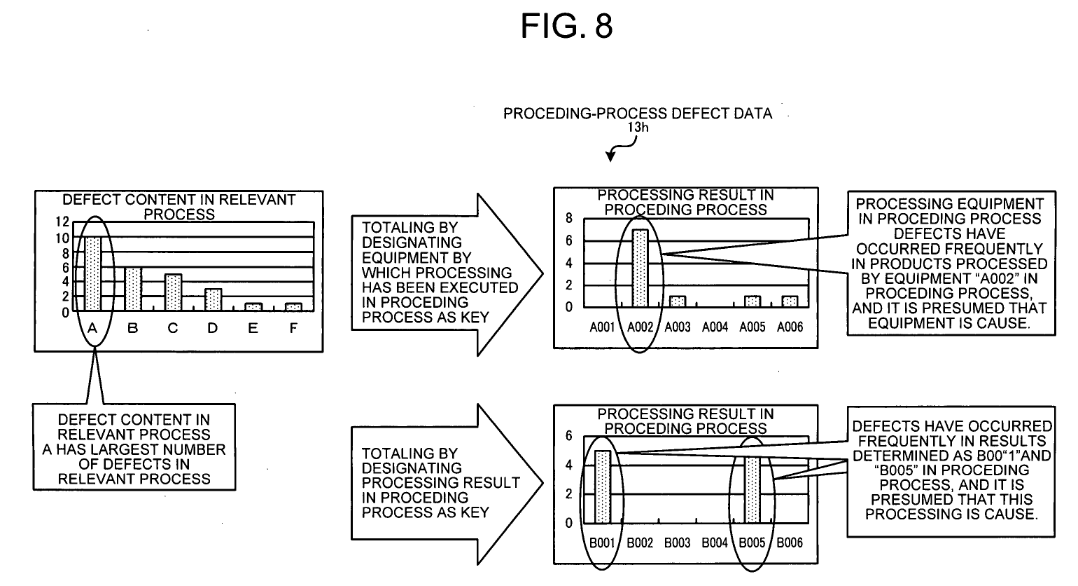

FIG. 8 is a graph of an example of preceding-process defect data 13h shown in FIG. 2. The respective values of the totaling result of the defect content in a certain process and the frequency of defects for each processing equipment in the preceding process, and the totaling result of the frequency of defects for each processing result in the preceding process are graphically shown, but the respective values are stored as numerical values in the database 13.

The totaling result of the defect contents totaled in a certain process and the totaling result of the production data or the test data in the preceding process thereof are stored in association with each other in the preceding-process defect data 13h.

In the example shown in FIG. 8, the totaling result of the defect content in the process and the frequency of defects for each processing equipment in the preceding process, and the totaling result of the frequency of defects for each processing result in the preceding process are stored in association with each other.

For example, when the number of a defect content “A” is the largest in the process, and the frequency of defects in the processing equipment “A002” is the highest in the preceding process, it is presumed that the processing equipment “A002” can be the cause of the defect “A”.

When the frequency of defects relating to the processing results “B001” and “B005” in the preceding process is the highest, it is presumed that the processing corresponding thereto can be the cause of the defect. In this manner, the element in the preceding process, which is the cause of the defect detected in the process, is determined.

Referring back to FIG. 2, the information relating to the relation between a combination of the respective parts and the respective equipment and the yield is stored in the optimum-parts/equipments combination data 13i. Specifically, the optimum-parts/equipments combination data 13i includes optimum parts combination data in which the combination of the respective parts forming the product and the yield by the combination is stored, and optimum equipment combination data in which the combination of the combination of the respective parts and the equipment, and the yield by the combination are stored.

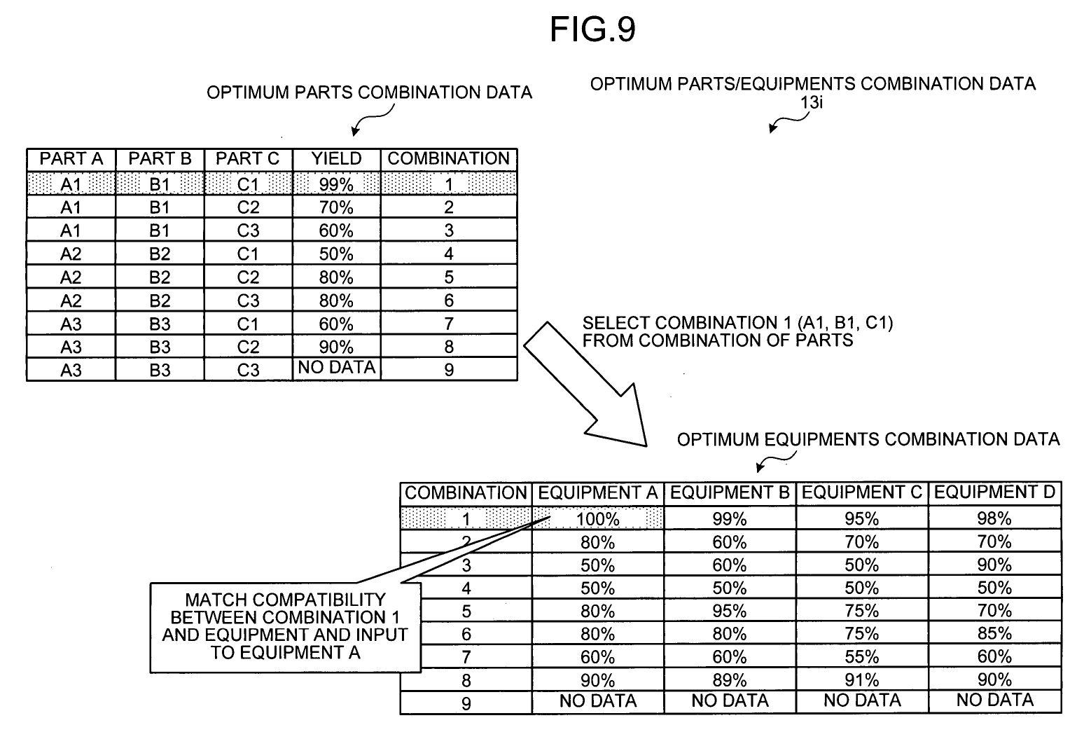

FIG. 9 is a schematic of an example of optimum-parts/equipments combination data 13i shown in FIG. 2. In the example shown in FIG. 9, there are three types of parts, part A, part B, and part C. There are three parts “A1”, “A2”, and “A3” with different manufacturer or lot in the part A, there are three parts “B1”, “B2”, and “B3” with different manufacturer or lot in the part B, and there are three parts “C1”, “C2”, and “C3” with different manufacturer or lot in the part C.

Since the combination of parts “A1”, “B1”, and “C1” has the highest yield (yield: 99%), this combination is selected as the optimum combination of the parts. Thereafter, the optimum combination of equipment is selected by referring to the optimum equipment combination data.

In the example shown in FIG. 9, the yield when processing is executed in the equipment A, the equipment B, the equipment C, and the equipment D with respect to the respective combinations is shown. Since the yield with respect to parts combination “1” is the highest (yield: 100%) in the equipment A, the equipment A is selected as the optimum equipment.

Referring back to FIG. 2, the control unit 155 in the manufacturing control apparatus 15 controls the entire manufacturing control apparatus 15. The control unit 155 includes a work-schedule/instruction-information creating unit 155a, an same-type equipment-defect determining unit 155b, a time-series defect determining unit 155c, a preceding-process defect determining unit 155d, and an optimum-parts/equipments-combination determining unit 155e.

The work-schedule/instruction-information creating unit 155a creates the work schedule data as explained with reference to FIG. 3 and the work instruction data as explained with reference to FIG. 4, to store these data in the database 13, and transmits the work schedule to the web server 16, the portable information terminal 19, the mobile phone 20, the e-mail receiving terminal 21, and the like, to notify the information to the operator.

Specifically, the work-schedule/instruction-information creating unit 155a reads the basic data 13a and the production/test data 13b from the database 13 and calculates the finish time from the information of the start time of each processing and the standard time required for each processing.

The work-schedule/instruction-information creating unit 155a checks whether an operator who executes the work is assigned for each equipment, and when the operator is assigned, creates a work schedule by rearranging the works in order of processing to be finished earlier for each operator.

When the operator is not assigned for each equipment, the work-schedule/instruction-information creating unit 155a creates a work schedule for each process by rearranging the works in order of processing to be finished earlier for each process. The work schedule is created for each process in this example, but the works can be rearranged in order of processing to be finished earlier, and the work schedule for all processes can be created for the processing included in all processes.

The work-schedule/instruction-information creating unit 155a calculates the distance between the position of the operator and the positions of the respective equipment having finished the processing and being in a suspended state, and creates a work instruction by rearranging the works to be executed by the respective equipment in an increasing order of the distance.

The same-type equipment-defect determining unit 155b creates the defect occurrence comparison data explained with reference to FIG. 5 and the defect-occurrence time-series data explained with reference to FIG. 6, to determine the cause of the defect by comparing the defective states in the same-type pieces of equipment.

Specifically, the same-type equipment-defect determining unit 155b calculates the fraction defective in the same-type respective equipment and the fraction defective mean value, and stores the information in the database 13. The same-type equipment-defect determining unit 155b determines whether the defect has occurred due to parts or due to particular equipment, by comparing these values with a predetermined threshold.

The same-type equipment-defect determining unit 155b then transmits the determination result to the web server 16, the portable information terminal 19, the mobile phone 20, the e-mail receiving terminal 21, and the like, to notify the operator of the determination result.

The time-series defect determining unit 155c creates the time-series defect data 13g as explained with reference to FIG. 7, and stores the data in the database 13. The time-series defect determining unit 155c determines the cause of the defect based on the time series change in the defect occurrence in the same-type pieces of equipment.

Specifically, the time-series defect determining unit 155c calculates the fraction defective in one day, the 5-day average of the fraction defective, and the 25-day average of the fraction defective, and compares these values with predetermined thresholds or compares the 5-day average with the 25-day average, to determine the cause of the defect occurrence.

The time-series defect determining unit 155c then transmits the determination result to the web server 16, the portable information terminal 19, the mobile phone 20, the e-mail receiving terminal 21, and the like, to notify the operator of the determination result.

The preceding-process defect determining unit 155d creates the preceding-process defect data 13h as explained with reference to FIG. 8, when the defect is detected in a certain process, and stores the data in the database 13. The preceding-process defect determining unit 155d determines which element in the preceding process has the cause of the detected defect.

Specifically, the preceding-process defect determining unit 155d totals the frequency of defects in the preceding process for each equipment, for each processing result, for each operator, and for each element such as parts and parts-lots. The preceding-process defect determining unit 155d checks whether there is an element having an outstanding frequency of defects as a result of totaling, and when there is an element having an outstanding frequency of defects, determines that there is a high possibility that the element has a problem.

The preceding-process defect determining unit 155d transmits the determination result to the web server 16, the portable information terminal 19, the mobile phone 20, the e-mail receiving terminal 21, and the like, to notify the operator of the determination result.

The optimum-parts/equipments-combination determining unit 155e creates the optimum-parts/equipments combination data 13i as explained with reference to FIG. 9 and stores the data in the database 13. The optimum-parts/equipments-combination determining unit 155e determines the combination of the parts and the equipment having a high production yield.

Specifically, the optimum-parts/equipments-combination determining unit 155e checks the relation between the combination of parts of products produced in the past and the equipment, and the yield, and at the time of producing a new product, determines which combination of parts has the highest yield, and also determines which equipment has the highest yield with respect to the combination of parts.

The optimum-parts/equipments-combination determining unit 155e transmits the information of the optimum combination of parts and equipment to the web server 16, the portable information terminal 19, the mobile phone 20, the e-mail receiving terminal 21, and the like, to notify the operator of the determination result.

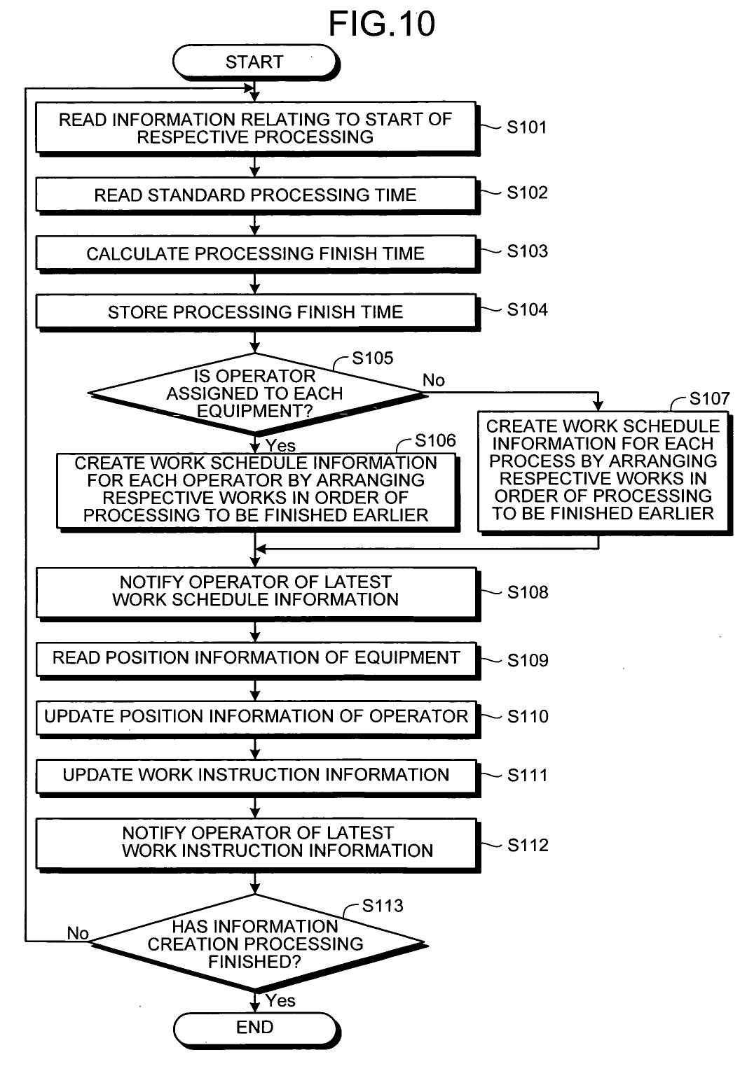

FIG. 10 is a flowchart of a processing procedure for a work-schedule creating process.

The work-schedule/instruction-information creating unit 155a in the manufacturing control apparatus 15 reads the information relating to the start of the respective processing (step S101). Specifically, the work-schedule/instruction-information creating unit 155a reads the production/test data 13b, in which information such as the identification number of the equipment for the processing, the product type, the product lot number, the processing start time, and the operator identification number is stored, from the database 13.

The work-schedule/instruction-information creating unit 155a reads the basic data 13a, in which the information such as the standard processing time required for the respective processing is stored, from the database 13 (step S102). The work-schedule/instruction-information creating unit 155a then calculates the processing finish time from the processing start time and the standard processing time (step S103), and stores the information of the calculated processing finish time in the database 13 as the production/test data 13b (step S104).

The work-schedule/instruction-information creating unit 155a then checks whether an operator is assigned to each equipment by reading the basic data 13a in the database 13 (step S105).

When the operator is assigned to each equipment (step S105, Yes), the work-schedule/instruction-information creating unit 155a creates information of the work schedule for each operator by referring to the information of the processing finish time and arranging the respective works in order of processing to be finished earlier (step S106), transmits the work schedule to the web server 16, the portable information terminal 19, the mobile phone 20, the e-mail receiving terminal 21, and the like, to notify the operator of the latest work schedule information (step S108).

When an operator is not assigned to each equipment (step S105, No), the work-schedule/instruction-information creating unit 155a creates information of the work schedule for each process by referring to the information of the processing finish time and arranging the respective works in order of processing to be finished earlier (step S107), transmits the work schedule information to the web server 16, the portable information terminal 19, the mobile phone 20, the e-mail receiving terminal 21, and the like, to notify the operator of the latest work schedule information (step S108).

The work schedule information is created by arranging the respective works in order of processing to be finished earlier for each process, and the work schedule information is notified to the operator. However, the work schedule information can be created by arranging the respective works included in all processes in order of processing to be finished earlier, and the work schedule information can be notified to the operator.

The work-schedule/instruction-information creating unit 155a reads the information of the equipment position from the basic data 13a in the database 13 (step S109). The work-schedule/instruction-information creating unit 155a then reads the information indicating that a certain operator has started the work by certain equipment from the production/test data 13b in the database 13 and determines the position of the operator from the equipment position (step S110).

The work-schedule/instruction-information creating unit 155a updates the work instruction information already notified to the operator, based on the positions of the equipment and the operator (step S111). The creation processing of the work instruction information will be explained later.

The work-schedule/instruction-information creating unit 155a transmits the updated latest work instruction information to the web server 16, the portable information terminal 19, the mobile phone 20, the e-mail receiving terminal 21, and the like, to notify the operator of the latest work instruction information (step S112).

Thereafter, the work-schedule/instruction-information creating unit 155a checks whether an input instructing to finish the work schedule information creation processing has been received from an administrator or the like of the manufacturing control apparatus 15 (step S113), and when the input has not been received yet (step S113, No), returns to step S101 to continue the subsequent processing.

In this case, at step S101, the information relating to the start of respective processing newly collected from the assembly line 10 or the testing machines 11a and 11b is read from the database 13. Accordingly, the work schedule can be updated to the latest information by modifying the program, and can be notified to the operator.

At step S113, when an input instructing to finish the creation processing is received (step S113, Yes), the work-schedule/instruction-information creating unit 155a finishes the work-schedule creating process.

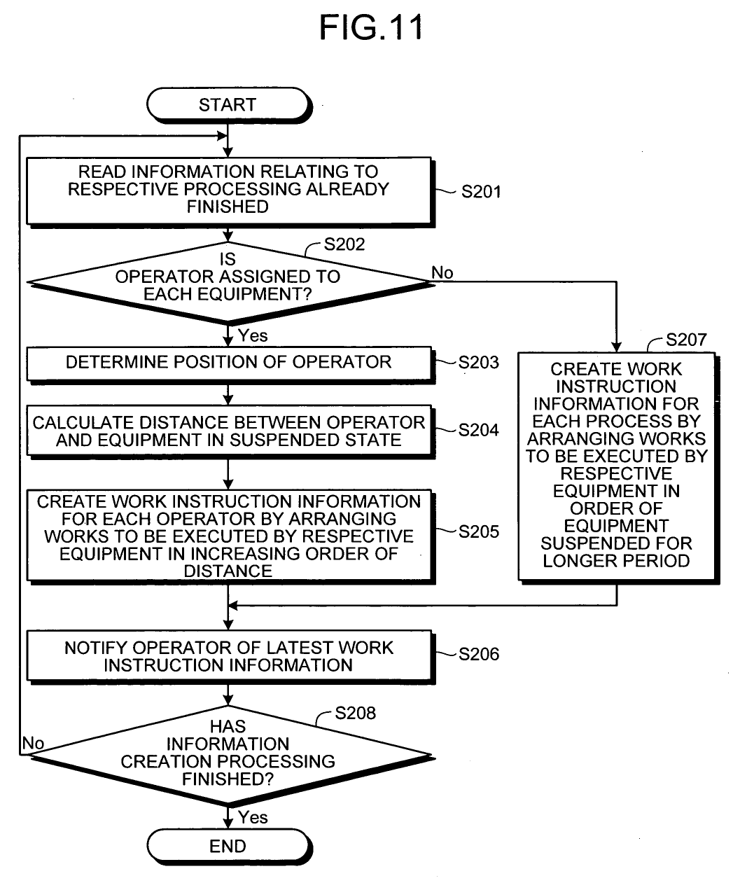

FIG. 11 is a flowchart of a processing procedure for a work-instruction creating process.

The work-schedule/instruction-information creating unit 155a in the manufacturing control apparatus 15 reads the information relating to the respective processing already finished (step S201). Specifically, the work-schedule/instruction-information creating unit 155a reads the production/test data 13b, in which the information such as the identification number of the equipment having performed the processing, the product type, the product lot number, the processing finish time, the processing result, and the operator identification number is stored, from the database 13.

The work-schedule/instruction-information creating unit 155a checks whether the operator is assigned to each equipment by reading the basic data 13a in the database 13 (step S202).

When the operator is assigned to each equipment (step S202, Yes), the work-schedule/instruction-information creating unit 155a reads the position information of the equipment, with which the operator has performed the last work, from the production/test data 13b in the database 13 to determine the position of the operator from the position information (step S203).

The work-schedule/instruction-information creating unit 155a then calculates the distance between the operator and the equipment that has finished the processing and is in a suspended state (step S204). The work-schedule/instruction-information creating unit 155a creates the work instruction information for each operator by arranging the works to be executed by each equipment in an increasing order of the distance (step S205), transmits the work instruction information to the web server 16, the portable information terminal 19, the mobile phone 20, the e-mail receiving terminal 21, and the like, to notify the operator of the latest work instruction information (step S206)

When an operator is not assigned to each equipment (step S202, No), the work-schedule/instruction-information creating unit 155a creates work instruction information for each process by arranging the works to be executed by respective equipment in order of equipment suspended for a longer period for each process (step S207), transmits the work schedule information to the web server 16, the portable information terminal 19, the mobile phone 20, the e-mail receiving terminal 21, and the like, to notify the operator of the latest work instruction information (step S206).

The work instruction information for each process is created by arranging the respective works in order of equipment suspended for a longer period for each process, and is notified to the operator. However, the work instruction information for all processes can be created by arranging the respective works in order of equipment suspended for a longer period, of the equipment used in all processes, and can be notified to the operator.

Thereafter, the work-schedule/instruction-information creating unit 155a checks whether an input instructing to finish the work schedule information creation processing has been received from the administrator or the like of the manufacturing control apparatus 15 (step S208). When the input has not been received yet (step S208, No), the process returns to step S201 to continue the subsequent processing.

When the input instructing to finish the creation processing is received (step S208, Yes), the work-schedule/instruction-information creating unit 155a finishes the work-instruction creating process.

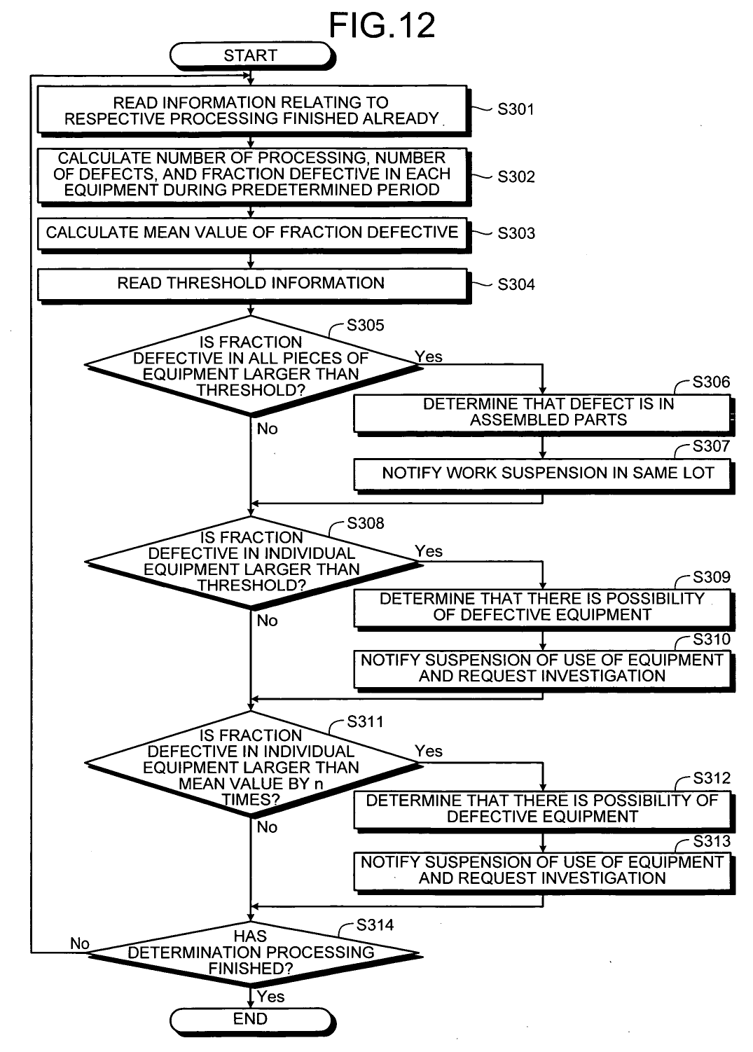

FIG. 12 is a flowchart of a processing procedure for determining a defect cause based on comparison of fraction defective between same kinds of equipments.

The same-type equipment-defect determining unit 155b in the manufacturing control apparatus 15 reads information relating to respective processing finished already (step S301). Specifically, the same-type equipment-defect determining unit 155b reads the production/test data 13b, in which the information such as the identification number of the equipment having performed the processing, the product type, the product lot number, the processing finish time, the processing result, and the operator identification number is stored, from the database 13.

The same-type equipment-defect determining unit 155b then calculates the number of processing, the number of defects, and the fraction defective in each equipment during a predetermined period (step S302), and calculates the mean value of the fraction defective in each equipment (step S303).

The same-type equipment-defect determining unit 155b then reads the threshold data 13c from the database 13 (step S304) and checks whether the fraction defective in all pieces of equipment is larger than the threshold (step S305).

When the fraction defective in all pieces of equipment is larger than the threshold (step S305, Yes), the same-type equipment-defect determining unit 155b determines that the defect is not in the equipment but in the assembled parts (step S306), transmits the information instructing to suspend the operation in the same lot to the web server 16, ,the portable information terminal 19, the mobile phone 20, the e-mail receiving terminal 21, and the like, to notify the operator of the information (step S307).

When it is notified to stop the operation in the same lot (step S307), or when the fraction defective in all pieces of equipment is not larger than the threshold (step S305, No), the same-type equipment-defect determining unit 155b checks whether the fraction defective in individual equipment is larger than the threshold (step S308).

When the fraction defective in the individual equipment is larger than the threshold (step S308, Yes), the same-type equipment-defect determining unit 155b determines that there is a possibility that a defect has occurred in the equipment having the fraction defective larger than the threshold (step S309), suspends the use of the equipment, transmits the information instructing to perform investigation to the web server 16, the portable information terminal 19, the mobile phone 20, the e-mail receiving terminal 21, and the like, to notify the operator of the information (step S310).

When it is notified to suspend the use of the equipment and perform investigation (step S310), or when the fraction defective in the individual equipment is not larger than the threshold (step S308, No), the same-type equipment-defect determining unit 155b checks whether the fraction defective in the individual equipment is larger than a mean value by n times (step S311). “n” is a threshold for the mean value stored in the database 13 as the threshold data 13c.

When the fraction defective in the individual equipment is larger than the mean value by n times (step S311, Yes), the same-type equipment-defect determining unit 155b determines that there is a possibility that a defect has occurred in the equipment having the fraction defective larger than the mean value by n times (step S312), transmits the information instructing to suspend the use of the equipment and perform investigation to the web server 16, the portable information terminal 19, the mobile phone 20, the e-mail receiving terminal 21, and the like, to notify the operator of the information (step S313).

When it is notified to suspend the use of the equipment and perform investigation (step S313), or when the fraction defective in the individual equipment is not larger than the mean value by n times (step S308, No), the same-type equipment-defect determining unit 155b checks whether an input instructing to finish the defect cause determining process has been received from the administrator or the like of the manufacturing control apparatus 15 (step S314). When the input has not been received yet (step S314, No), the process returns to step S301 to continue the subsequent processing.

When the input instructing to finish the determining process is received (step S314, Yes), the same-type equipment-defect determining unit 155b finishes the defect cause determining process.

When the cause of the defect is determined from the time series change in the fraction defective in the same-type pieces of equipment as explained with reference to FIG. 6, the processing can be performed in the same manner. In this case, specifically, the same-type equipment-defect determining unit 155b calculates the time series change in the fraction defective in each equipment at step S302.

Instead of steps S305 to S313, the same-type equipment-defect determining unit 155b determines whether the fraction defective in the all pieces of equipment at a certain point in time is larger than the threshold. When the fraction defective is larger than the threshold, the same-type equipment-defect determining unit 155b determines that there is a high possibility that there is a defective part, transmits the information instructing to suspend the operation in the same lot to the web server 16, the portable information terminal 19, the mobile phone 20, the e-mail receiving terminal 21, and the like, to notify the operator of the information.

When the operator is notified to suspend the operation in the same lot, or when the fraction defective in certain equipment at a certain point in time is larger than the threshold, the same-type equipment-defect determining unit 155b determines that there is a high possibility of a defect in the equipment, transmits information instructing to suspend the use of the equipment and perform investigation to the web server 16, the portable information terminal 19, the mobile phone 20, the e-mail receiving terminal 21, and the like, to notify the operator of the information.

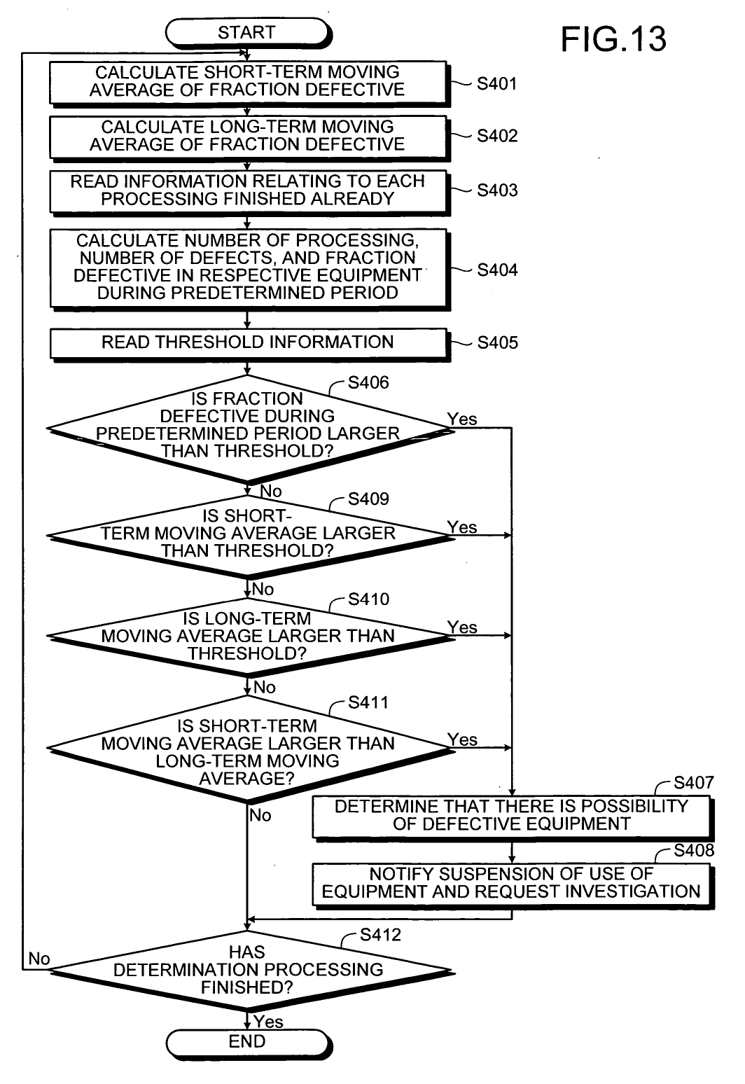

FIG. 13 is a flowchart of a processing procedure for determining a defect cause based on a time series change in the fraction defective in single equipment.

The time-series defect determining unit 155c in the manufacturing control apparatus 15 calculates the moving average of the fraction defective for a short period (for example, 5 days) from the information of the fraction defective for one day in the respective equipment (step S401), and further calculates the moving average of the fraction defective for a long period (for example, 25 days) (step S402).

The time-series defect determining unit 155c reads the information relating to each processing finished already (step S403). Specifically, the time-series defect determining unit 155c reads the production/test data 13b, in which the information such as the identification number of the equipment having performed the processing, the product type, the product lot number, the processing finish time, the processing result, and the identification number of the operator is stored, from the database 13.

The time-series defect determining unit 155c calculates the number of processing, the number of defects, and the fraction defective in the respective equipment during the predetermined period (step S404). When the predetermined period is one day, the information of the fraction defective for one day used at the time of calculating the moving average can be used directly.

The time-series defect determining unit 155c reads the threshold data 13c from the database 13 (step S405), and checks whether the fraction defective during the predetermined period (for example, one day) is larger than the threshold (step S406).

When the fraction defective during the predetermined period (for example, one day) is larger than the threshold (step S406, Yes), the time-series defect determining unit 155c determines that there is a possibility that a defect has occurred in the equipment (step S407), transmits information instructing to suspend the use of the equipment and perform investigation to the web server 16, the portable information terminal 19, the mobile phone 20, the e-mail receiving terminal 21, and the like, to notify the operator of the information (step S408).

When the fraction defective during the predetermined period (for example, one day) is not larger than the threshold (step S406, No), the time-series defect determining unit 155c checks whether the short-term moving average is larger than the threshold (step S409).

When the short-term moving average is larger than the threshold (step S409, Yes), the time-series defect determining unit 155c determines that there is a possibility that a defect has occurred in the equipment (step S407), and transmits information instructing to suspend the use of the equipment and perform investigation to the web server 16, the portable information terminal 19, the mobile phone 20, the e-mail receiving terminal 21, and the like, to notify the operator of the information (step S408).

When the short-term moving average is not larger than the threshold (step S409, No), the time-series defect determining unit 155c checks whether the long-term moving average is larger than the threshold (step S410).

When the long-term moving average is larger than the threshold (step S410, Yes), the time-series defect determining unit 155c determines that there is a possibility that a defect has occurred in the equipment (step S407), transmits information instructing to suspend the use of the equipment and perform investigation to the web server 16, the portable information terminal 19, the mobile phone 20, the e-mail receiving terminal 21, and the like, to notify the operator of the information (step S408) When the long-term moving average is not larger than the threshold (step S410, No), the time-series defect determining unit 155c checks whether the short-term moving average is larger than the long-term moving average (step S411).

When the short-term moving average is larger than the long-term moving average (step S411, Yes), the time-series defect determining unit 155c determines that there is a possibility that a defect has occurred in the equipment (step S407), transmits information instructing to suspend the use of the equipment and perform investigation to the web server 16, the portable information terminal 19, the mobile phone 20, the e-mail receiving terminal 21, and the like, to notify the operator of the information (step S408).

When it is notified to suspend the use of the equipment and perform investigation (step 408), or when the short-term moving average is not larger than the long-term moving average (step S411, No), the time-series defect determining unit 155c checks whether an input instructing to finish the defect cause determining process has been received from the administrator or the like of the manufacturing control apparatus 15 (step S412). When the input has not been received yet (step S412, No), the process returns to step S401 to continue the subsequent processing.

When the input instructing to finish the determining process has been received (step S412, Yes), the time-series defect determining unit 155c finishes the defect cause determining process.

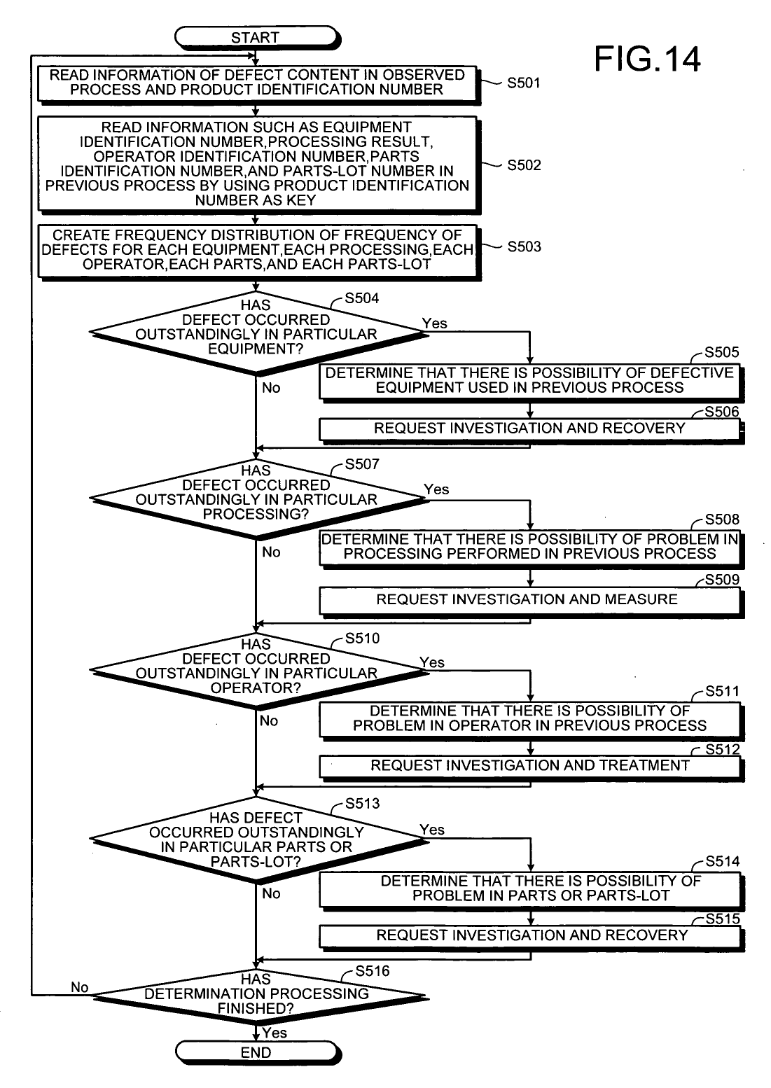

FIG. 14 is a flowchart of a processing procedure for determining an element that is a cause of a defect in a preceding process.

The preceding-process defect determining unit 155d in the manufacturing control apparatus 15 reads the information of the defect content in the observed process and the product identification number from the production/test data 13b in the database 13 (step S501).

The preceding-process defect determining unit 155d reads the information such as the equipment (jig) identification number, the processing result, the operator identification number, parts, lot number of the parts in the preceding process in which the product has been processed, from the production/test data 13b in the database 13, by using the product identification number as a search key (step S502), and creates frequency distribution of the frequency of the defects for each equipment (jig), each processing, each operator, each parts, and each parts-lot (step S503).

The preceding-process defect determining unit 155d then checks whether the defect has occurred outstandingly in particular equipment (step S504). Specifically, when the frequency of the defects is higher by a predetermined number as compared to other pieces of equipment, the preceding-process defect determining unit 155d determines that the defect occurrence is outstanding.

When the defect has occurred outstandingly in particular equipment (step S504, Yes), the preceding-process defect determining unit 155d determines that there is a possibility that a defect has occurred in the equipment used in the preceding process (step S505), transmits information requesting an investigation or recovery of the defect to the web server 16, the portable information terminal 19, the mobile phone 20, the e-mail receiving terminal 21, and the like, to notify the operator of the information (step S506).

When the request for investigation or recovery of the defect of the equipment is notified (step S506), or when the defect has not occurred outstandingly in the particular equipment (step S504, No), the preceding-process defect determining unit 155d determines whether a defect has occurred outstandingly in a particular processing result (step S507).

When the defect has occurred outstandingly in a particular processing result (step S507, Yes), the preceding-process defect determining unit 155d determines that there is a possibility of a problem in the processing executed in the preceding process (step S508), transmits information requesting an investigation or a measure with respect to the processing result to the web server 16, the portable information terminal 19, the mobile phone 20, the e-mail receiving terminal 21, and the like to notify the operator of the information (step S509).

When the request for an investigation or a measure with respect to the processing result is notified (step S509), or when the defect has not occurred outstandingly in a particular processing result (step S507, No), the preceding-process defect determining unit 155d checks whether the defect has occurred outstandingly in a particular operator (step S510).

When the defect has occurred outstandingly in the particular operator (step S510, Yes), the preceding-process defect determining unit 155d determines that there is a possibility of a problem in the operator who has executed the work in the preceding process (step S511), transmits information requesting an investigation or treatment of the operator to the web server 16, the portable information terminal 19, the mobile phone 20, the e-mail receiving terminal 21, and the like to notify the operator of the information (step S512).

When the request for an investigation or treatment of the operator has been notified (step S512), or when the defect has not occurred outstandingly in a particular operator (step S510, No), the preceding-process defect determining unit 155d determines whether the defect has occurred outstandingly in a particular part or a parts-lot (step S513).

When the defect has occurred outstandingly in a particular part or a parts-lot (step S513, Yes), the preceding-process defect determining unit 155d determines that there is a possibility of a problem in the part or the parts-lot processed in the preceding process (step S514), transmits the information requesting an investigation or recovery of the part or the parts-lot to the web server 16, the portable information terminal 19, the mobile phone 20, the e-mail receiving terminal 21, and the like to notify the operator of the information (step S515).

When the request for an investigation or recovery of the part or the parts-lot has been notified (step S515), or when the defect has not occurred outstandingly in a particular part or parts-lot (step S513, No), the preceding-process defect determining unit 155d determines whether an input instructing to finish the defect cause determining process has been received from the administrator or the like of the manufacturing control apparatus 15 (step S516). When the input has not been received yet (step S516, No), the process returns to step S501 to continue the subsequent processing.

When the input instructing to finish the determining process has been received (step S516, Yes), the preceding-process defect determining unit 155d finishes the defect cause determining process.

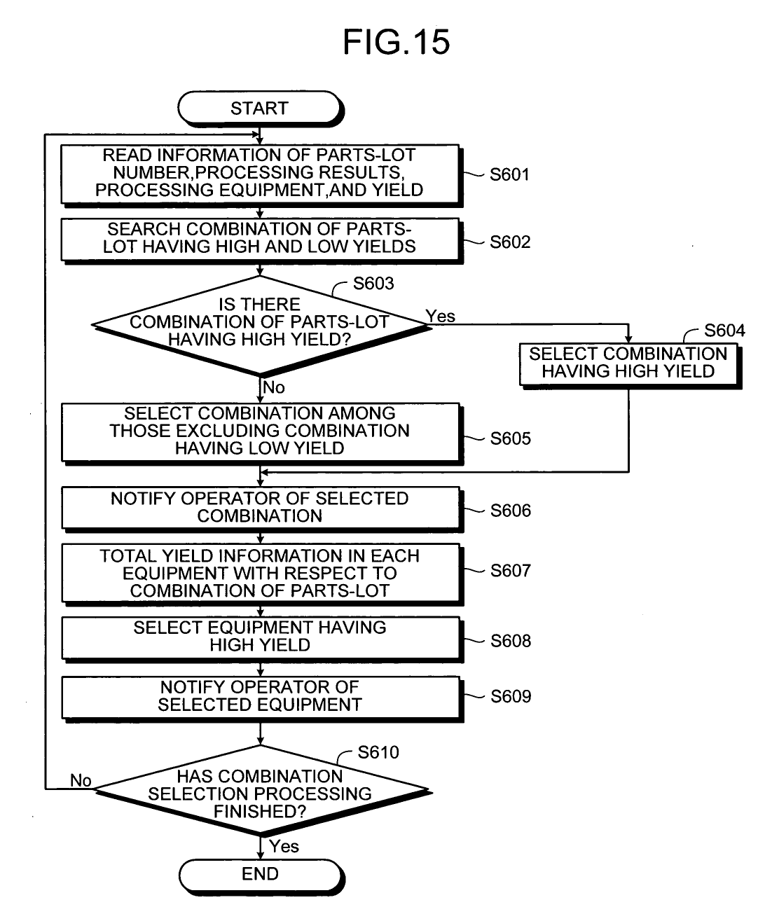

FIG. 15 is a flowchart of a processing procedure for selecting a combination of parts and equipment having a high production yield.

The optimum-parts/equipments-combination determining unit 155e in the manufacturing control apparatus 15 reads information such as the parts-lot number, processing results, processing equipment, and yield from the production/test data 13b in the database 13 (step S601).

The optimum-parts/equipments-combination determining unit 155e then searches a combination of parts-lot having a high yield (for example, a combination having a yield of 95% or more), and a combination of parts-lot having a low yield (for example, a combination having a yield of 70% or less) (step S602).

The optimum-parts/equipments-combination determining unit 155e then checks whether there is a combination of parts-lot having a high yield (step S603), and when there is the combination of parts-lot having a high yield (step S603, Yes), selects the combination (step S604), transmits the information of the selected combination to the web server 16, the portable information terminal 19, the mobile phone 20, the e-mail receiving terminal 21, and the like to notify the operator of the information (step S606).

When there is no combination of parts-lot having a high yield (step S603, No), the optimum-parts/equipments-combination determining unit 155e selects a combination among those excluding combinations of parts-lot having a low yield (step S605), transmits the information of the selected combination to the web server 16, the portable information terminal 19, the mobile phone 20, the e-mail receiving terminal 21, and the like to notify the operator of the information (step S606).

In this case, the optimum-parts/equipments-combination determining unit 155e selects a combination having a yield equal to or higher than a predetermined threshold (for example, 80% or more). If there is no combination having a yield equal to or higher than the predetermined threshold, the optimum-parts/equipments-combination determining unit 155e selects a combination with a new parts-lot.

The optimum-parts/equipments-combination determining unit 155e then refers to the production/test data 13b in the database 13, to total the yield information in each equipment having performed the processing by using the combination of parts-lot (step S607), and selects the equipment having a high yield (step S608).

If there is no equipment having a high yield, the optimum-parts/equipments-combination determining unit 155e selects equipment having reserve processing capacity among those excluding the equipment having a low yield.

The optimum-parts/equipments-combination determining unit 155e transmits the information of the selected equipment to the web server 16, the portable information terminal 19, the mobile phone 20, the e-mail receiving terminal 21, and the like to notify the operator of the information (step S609).

The optimum-parts/equipments-combination determining unit 155e then checks whether an input instructing to finish the selection processing for selecting a combination of parts and equipment has been received from the administrator or the like of the manufacturing control apparatus 15 (step S610). When the input has not been received yet (step S610, No), the process returns to step S601 to continue the subsequent processing.

When the input instructing to finish the combination selection processing has been received (step S610, Yes), the optimum-parts/equipments-combination determining unit 155e finishes the combination selection processing.

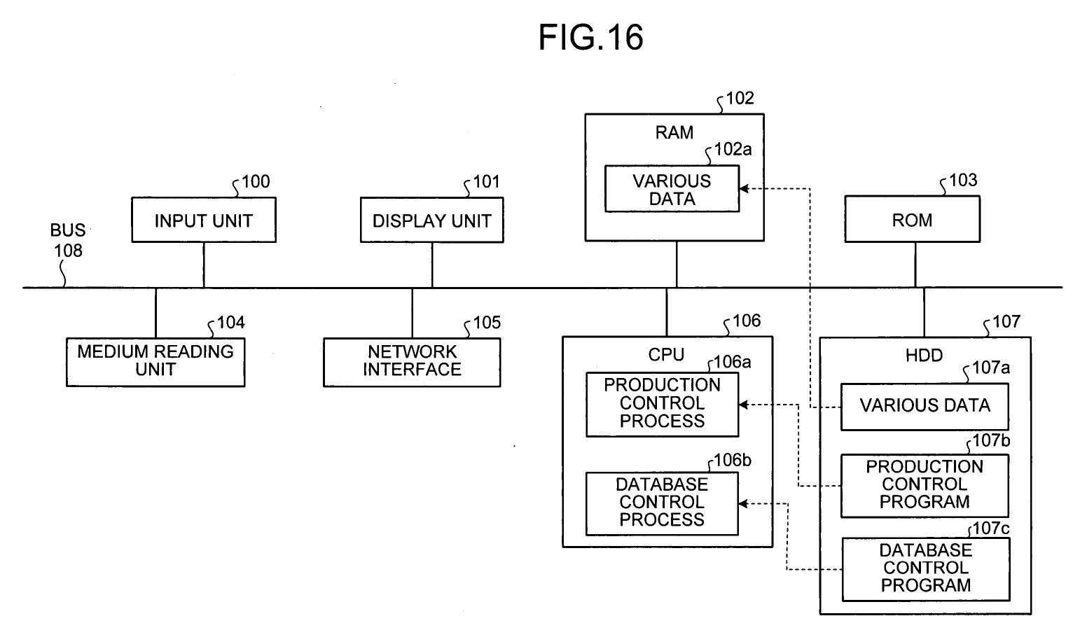

The various types of processing explained According to the present embodiment can be realized by executing a program prepared beforehand, by a computer. FIG. 16 is a schematic of a hardware configuration of a computer to implement the manufacturing control apparatus shown in FIG. 2.

The computer is formed by connecting an input device 100 that receives inputs of data from users, a display device 101, a random access memory (RAM) 102, a read only memory (ROM) 103, a medium reader 104 that reads a program from a recording medium in which various programs are recorded, a network interface 105 that transfers data between other computers via a network, a central processing unit (CPU) 106, and a HDD 107 with each other by a bus 108.

The HDD 107 stores a program exhibiting the function same as that of the manufacturing control apparatus 15, that is, a manufacturing control program 107b and a database control program 107c. The manufacturing control program 107b and the database control program 107c can be stored by being appropriately integrated or dispersed.

The CPU 106 reads the manufacturing control program 107b and the database control program 107c from the HDD 107 and executes the programs, so as to function as a manufacturing control process 106a and a database control process 106b.

The manufacturing control process 106a corresponds to the work-schedule/instruction-information creating unit 155a, the same-type equipment-defect determining unit 155b, the time-series defect determining unit 155c, the preceding-process defect determining unit 155d, and the optimum-parts/equipments-combination determining unit 155e of the control unit 155 shown in FIG. 2. The database control process 106b corresponds to the database control unit 154.

The HDD 107 stores various data 107a. The various data 107a corresponds to the basic data 13a, the production/test data 13b, the threshold data 13c, the work schedule data 13d, the work instruction data 13e, the same-kind equipment-defect data 13f, the time-series defect data 13g, the preceding-process defect data 13h, and the optimum-parts/equipments combination data 13i stored in the database 13 shown in FIG. 2.

The CPU 106 stores the various data 107a in the HDD 107, reads the various data 107a from the HDD 107 and stores the various data 107a in the RAM 102, and executes data processing based on the various data 107a stored in the RAM 102.

The manufacturing control program 107b and the database control program 107c are not necessarily initially stored in the HDD 107.

For example, respective programs can be stored in a “portable physical media” such as a flexible disk (FD), a CD-ROM, a magneto optical (MO) disk, a digital versatile disk (DVD), an optical magnetic disk, and an integrated circuit (IC) card inserted into the computer, or a “fixed physical media” such as a HDD equipped inside or outside the computer, or “another computer (or server)” connected to the computer via a public line, the Internet, a local area network (LAN), or a wide area network (WAN), and the computer can read the respective programs from these media to execute the programs.

As described above, according to the present embodiment, the database 13 stores the production/test data 13b as the information relating to the production of the product in respective production processes, and the preceding-process defect determining unit 155d obtains the information relating to the production in a second production process, which is a production process prior to a first production process, from the database 13 when a defect has been detected in the first production process, to determine the element in the second production process, which is the cause of the defect detected in the first production process, based on the obtained information. As a result, the defective state and the cause thereof can be determined in detail.

Furthermore, according to the present embodiment, the optimum-parts/equipments-combination determining unit 155e extracts a combination of the parts or the equipment having a high yield based on the production/test data 13b stored in the database 13, and the information relating to the production of the product based on the extracted combination is stored in the database 13. As a result, the defective state and the cause thereof can be determined in detail, and the product quality can be further improved.

Moreover, according to the present embodiment, since the time-series defect determining unit 155c checks a time series change in the defective state based on the production/test data 13b stored in the database 13, to determine the cause of the defect, the defective state and the cause thereof can be determined in detail based on the transition in the defective state.

Furthermore, according to the present embodiment, the production/test data 13b is the processing start time, processing finish time, identification information of respectively used equipment, identification information of product lots, product types, identification information of respective products, processing results, defect information, identification information of operators, identification information of jigs, identification information of parts, or identification information of parts-lot. As a result, by collecting various types of information, the defective state and the cause thereof can be determined in detail.

Moreover, according to the present embodiment, the work-schedule/instruction-information creating unit 155a predicts the finish time of a plurality of processing from the standard processing time, and creates a work schedule of an operator by arranging works to be executed by the operator in order of processing to be finished earlier, and the information relating to the production of the product based on the created work schedule is stored in the database 13. As a result, the defective state and the cause thereof can be determined in detail, and the work schedule can be notified to the operator.

Furthermore, according to the present embodiment, the work-schedule/instruction-information creating unit 155a modifies the work schedule based on the production/test data 13b, and the information relating to the production of the product based on the modified work schedule is stored in the database 13. As a result, the work schedule can be updated, and the information of the latest work schedule can be notified to the operator.

Moreover, according to the present embodiment, the work-schedule/instruction-information creating unit 155a creates a work instruction in which works to be executed by the operator by using various types of equipment are arranged in an increasing order of distance between the position of the operator and the position of the equipment by which the operator executes respective processing. The information relating to the production of the product based on the created work instruction is stored in the database 13. As a result, the defective state and the cause thereof can be determined in detail, and the operator can execute the work efficiently, thereby increasing the operating rate of the equipment.

Furthermore, according to the present embodiment, the same-type equipment-defect determining unit 155b compares the defective states between same-type pieces of equipment by calculating a mean value, based on the production/test data 13b, to determine the cause of the defect. As a result, the equipment having a relatively high frequency of defects can be easily detected, and the defective state and the cause thereof can be determined in detail.

While the present embodiment of the present invention is described above, variously modified embodiments other than the ones described above can be made without departing from the scope of the technical spirit of the appended claims.

Of the respective processing explained According to the present embodiments, all or a part of the processing explained as being performed automatically can be performed manually, or all or a part of the processing explained as being performed manually can be performed automatically in a known method.

The information including the processing procedure, the control procedure, specific names, and various kinds of data and parameters shown in the specification or in the drawings can be optionally changed, unless otherwise specified.

The respective constituents of the illustrated apparatus are functionally conceptual, and the physically same configuration is not always necessary. In other words, the specific mode of dispersion and integration of the apparatus is not limited to the depicted ones, and all or a part thereof can be functionally or physically dispersed or integrated in an optional unit, according to the various kinds of load and the status of use.

All or an optional part of the various processing functions performed by the apparatus can be realized by the CPU or a program analyzed and executed by the CPU, or can be realized as hardware by a wired logic.

According to the present invention, the information relating the production of the product in respective production processes is stored, and when a defect is detected in the first production process, information relating to the production in the second production process, which is a production process prior to the first production process, is obtained, and an element in the second production process, which is the cause of the defect detected in the first production process, is determined based on the obtained information. Therefore, the defective state and the cause thereof can be determined in detail.

Furthermore, according to the present invention, a combination of parts or equipment having a high yield is extracted based on the stored information relating to the production of the product in the respective production processes, and the information relating to the production of the product based on the extracted combination is stored. Therefore, the defective state and the cause thereof can be determined in detail, and the product quality can be improved.

Moreover, according to the present invention, the cause of the defect is determined by checking the time series change in the defective state based on the stored information relating to the production of the product in the respective production processes. Therefore, the defective state and the cause thereof can be determined in detail based on the transition in the defective state.

Furthermore, according to the present invention, the information relating to the production includes processing start time, processing finish time, identification information of respectively used equipment, identification information of product lots, product types, identification information of respective products, processing results, defect information, identification information of operators, identification information of jigs, identification information of parts, and identification information of parts-lot. Therefore, by collecting various types of information, the defective state and the cause thereof can be determined in detail.

Moreover, according to the present invention, a work schedule of an operator is created by arranging works to be executed by the operator in order of processing to be finished earlier, by predicting the finish time of a plurality of processing, and the information relating to the production of the product based on the created work schedule is stored. Therefore, the defective state and the cause thereof can be determined in detail, and the work schedule can be notified to the operator.

According to the present invention, the work schedule is modified based on the stored information relating to the production of the product in the respective production processes, and the information relating to the production of the product based on the modified work schedule is stored. Therefore, the work schedule can be updated, and the information of the latest work schedule can be notified to the operator.

According to the present invention, a work instruction in which works to be executed by the operator by using various types of equipment are arranged in an increasing order of distance between the position of the operator and the position of the equipment by which the operator executes respective processing, and the information relating to the production of the product based on the created work instruction is stored. Therefore, the defective state and the cause thereof can be determined in detail, and the operator can execute the work efficiently, thereby increasing the operating rate of the equipment.

According to the present invention, the defective state is compared between same-type pieces of equipment based on the stored information relating to the production of the product in the respective production processes, to determine the cause of the defect. Therefore, the equipment having a relatively high frequency of defects can be easily detected, and the defective state and the cause thereof can be determined in detail.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An apparatus for controlling manufacturing of a product in a plurality of manufacturing processes including a first manufacturing process and a second manufacturing process, the first process preceding the second process, the apparatus comprising:
an information storing unit that stores information relating to the manufacturing of the product in each of the manufacturing processes;
an information acquiring unit that acquires, when a defect is detected in the second manufacturing process, information relating to the manufacturing of the product in the first manufacturing process from the information storing unit; and
an element determining unit that determines an element in the first manufacturing process, which is a cause of the defect detected in the second manufacturing process, based on the information acquired.

2. The apparatus according to claim 1, further comprising:
a combination extracting unit that extracts a combination of parts or equipments having a high production yield, based on the information stored in the information storing unit, wherein
the information storing unit stores information relating to the manufacturing of the product manufactured based on the combination extracted.

3. The apparatus according to claim 1, further comprising:
a time-series defect-cause determining unit that determines the cause of the defect by investigating a time series change of occurrence of the defect based on the information stored in the information storing unit.

4. The apparatus according to claim 1, wherein the information relating to the manufacturing of the product includes at least one of process start time, process end time, identification information for each equipment used, identification information for product lot, type of product, identification information for each product, processing result, defect information, identification information for operator, identification information for jig, identification information for part, and identification information for part lot.

5. The apparatus according to claim 1, further comprising:
a work-schedule creating unit that predicts process end times of a plurality of processes, and creates a work schedule of an operator by sorting works to be executed by the operator by process end time, wherein
the information storing unit stores information relating to the manufacturing of the product manufactured based on the work schedule created.

6. The apparatus according to claim 5, further comprising:
a work-schedule modifying unit that modifies the work schedule based on the information stored in the information storing unit, wherein
the information storing unit stores information relating to the manufacturing of the product manufactured based on the work schedule modified.

7. The apparatus according to claim 1, further comprising:
a work-instruction creating unit that creates a work instruction in which works to be executed by an operator using an equipment for each of the processes are sorted by a distance between a position of the operator and a position of the equipment, wherein
the information storing unit stores information relating to the manufacturing of the product manufactured based on the work instruction created.

8. The apparatus according to claim 1, further comprising:
a same-type equipment-defect-cause determining unit that determines the cause of the defect by comparing occurrence of the defect in same types of equipments based on the information stored in the information storing unit.

9. A method controlling manufacturing of a product in a plurality of manufacturing processes including a first manufacturing process and a second manufacturing process, the first process preceding the second process, the method comprising:
storing information relating to the manufacturing of the product in each of the manufacturing processes;
acquiring, when a defect is detected in the second manufacturing process, information relating to the manufacturing of the product in the first manufacturing process from the information stored at the storing; and
determining an element in the first manufacturing process, which is a cause of the defect detected in the second manufacturing process, based on the information acquired.

10. A computer-readable recording medium that stores a computer program for controlling manufacturing of a product in a plurality of manufacturing processes including a first manufacturing process and a second manufacturing process, the first process preceding the second process, wherein the computer program causes a computer to execute
storing information relating to the manufacturing of the product in each of the manufacturing processes;
acquiring, when a defect is detected in the second manufacturing process, information relating to the manufacturing of the product in the first manufacturing process from the information stored at the storing; and
determining an element in the first manufacturing process, which is a cause of the defect detected in the second manufacturing process, based on the information acquired.
